(19) United States
(12) Patent Application Publication
(10) Pub. No.: US 2015/0329800 A1
(43) Pub. Date: Nov. 19, 2015

(54) METHODS FOR PREVENTION AND REDUCTION OF SCALE FORMATION

(71) Applicant: IMERYS FILTRATION MINERALS, INC., San Jose, CA (US)

(72) Inventor: JIE LU, LOMPOC, CA (US)

(21) Appl. No.: 14/443,244

(22) PCT Filed: Nov. 13, 2013
(86) PCT No.: PCT/US13/69783

§ 371 Date: May 15, 2015

Related U.S. Application Data
(60) Provisional application No. 61/727,309, filed on Nov. 16, 2012.
(60) Provisional application No. 61/784,899, filed on Mar. 14, 2013.

(51) Int. Cl. C11D 3/12; C11D 11/00

(52) U.S. Cl. CPC C11D 3/1246; C11D 11/0017

(57) ABSTRACT

Methods of preventing or reducing scale formation or corrosion may include combining at least one scale-forming fluid including at least one scaling compound with at least one anti-scale material chosen from at least one scale-adsorbent agent. The methods may reduce or prevent the formation of scale on surfaces of liquid-related process equipment, such as boilers and heat exchangers.

### CLAIM OF PRIORITY

This PCT International Application claims the benefit of priority of U.S. Provisional Application Nos. 61/784,899, filed Mar. 14, 2013, and 61/727,309, filed Nov. 16, 2012, the subject matter of both of which is incorporated herein by reference in their entireties.

### FIELD OF THE INVENTION

Disclosed herein are an improved laundry detergent composition comprising an antiscale agent comprising a particulate alkaline earth silicate, and methods of preventing or reducing scale formation on clothing by combining the at least one anti-scale agent with a laundry detergent.

### BACKGROUND OF THE INVENTION

Scaling or scale formation generally involves the precipitation and deposition of dense materials on surfaces, such as clothing surfaces during the washing of laundry. Scale formation may occur when inorganic mineral salts (such as, for example, calcium carbonates, calcium sulfates, calcium oxalates, and barium sulfates) precipitate from liquids and deposit on the clothing or inside surfaces of the laundry washer system.

Scale formation on cloth during washing can cause discoloration and can make clothing undesirably stiff and hard.

Scale formation can be divided into several steps. Concentrations of cationic and anionic ions, such as Ca²⁺, Mg²⁺, Ba²⁺, CO₃²⁻, SO₄²⁻, C₂O₄²⁻, among others, may increase to concentrations that exceed solubility limits and combine to form ion pairs or salt molecules. Those salt molecules or ion pairs may then form microaggregates, which may further grow into nucleation centers for crystallization. Microcrystals may then form from the nucleation centers to become seeds, which may grow and agglomerate, and may precipitate and adhere to surfaces to grow into large crystals. After adhering to surfaces, these crystals may continue to grow and eventually form an adherent layer of scale on a surface. The crystal scale layer may continue to grow and build up, ultimately forming a scale deposit.

Various chemical anti-scalants, such as chelants, phosphates or phosphonates (organophosphates), polycarbonates, and components of polymers, have been developed to inhibit or reduce the formation of inorganic scales. These chemical anti-scalants typically work by one of the following mechanisms: precipitation threshold inhibition, dispersion, and crystal distortion/modification.

Precipitation threshold inhibition may be achieved, for example, by combining a chelant with scale-forming cations to form a stable complex that interrupts ion-pair formation of scale molecules and inhibits the nucleation of scale crystals. Another type of precipitation threshold inhibitor are chemicals that have multiple attachment sites and can inhibit the growth of microcrystals after nucleation by occupying the active growth sites of microcrystals and blocking access to scale-forming ions. Additional examples that can be classified as precipitation threshold inhibition are ion exchange softening and acidification. Ion exchange softening involves exchanging calcium and magnesium ions with sodium, and acidification involves removing one of the reactants necessary for carbonate precipitation through acid addiction.

For dispersion, anionic chemical dispersants modify the surface charges of scaling crystals such that the crystals are dispersed in solution and do not adhere or adsorb to each other to form scales. Anionic dispersants generally modify scaling crystals by adsorbing onto the surface of growing crystals, thereby increasing the anionic charge of the growing crystals and increasing the electrostatic charge repulsion between the crystals. A high anionic surface charge may increase the activation energy barrier to crystal agglomeration, which in turn produces a more stable dispersion of the colloidal microcrystals. Therefore, chemical dispersants may effectively prevent scaling by retarding crystal agglomeration. Anionic polymers containing carboxylic acid groups may be efficient chemical dispersants.

For crystal distortion/modification, some chemicals may be used to alter the crystal forms or shapes of growing crystals such that crystal adsorption or agglomeration is retarded and the deposit of scales to surfaces is reduced. These anti-sealant chemicals may selectively adsorb onto growing crystals, altering their surface properties and disrupting the lock-and-key fit between precipitating scaling species and the growing crystals. Modifying the crystal shape and reducing the numbers of contact surfaces not only may slow the rate of crystal growth, but may make it difficult for the crystals to form hard, tenacious deposits. The modified crystals may then be swept away from surfaces by process flows. Chemical anti-scalants, which act primarily as either threshold inhibitors or dispersants, may also function as crystal modifiers since they adsorb onto the crystal surfaces.

Chemical anti-scalants based on those three mechanisms discussed above, however, are not always effective due to the complexity of scale formation. For example, precipitation threshold inhibitors that use a chelant have the disadvantage of reacting on a stoichiometric ratio (i.e., one molecule of chelant reacts with, for example, one calcium ion), which may impose very high costs if a large volume of liquid needs to be treated. In addition, chemical anti-scalants may not work due to dissociation under high process temperature or pressure, or due to interference caused by impurities from the process water. Furthermore, besides high cost and low efficiency, chemical anti-scalants generally pose safety and environmental concerns.

U.S. Pat. Nos. 6,929,749 and 7,122,148 appear to disclose methods for inhibiting silica scale formation and corrosion in aqueous systems by pre-removal of hardness ions from the source water, maintenance of electrical conductivity, and elevation of the pH level. U.S. Pat. No. 4,995,986 appears to disclose a method of removing contaminants from wastewater by the addition of aqueous solutions of magnesium chloride and sodium silicate; however, it appears to focus on the in situ precipitation of an amorphous magnesium silicate by a controlled process of addition of magnesium salts and silicate salts—which could increase the amount of scale—and the subsequent removal of pollutants from the liquid media, which is not expected to give significant improvement in the removal of scalants. U.S. Pat. No. 4,713,177 may disclose a process for reducing calcium, magnesium, and aluminum salt scale build-up by adding a precipitating reagent to preferentially precipitate calcium, magnesium, and aluminum ions. PCT International Publication No. WO 84/02126 appears to disclose a method for preventing formation of calcium and magnesium scales by adding low or negligibly water soluble alkali metal silicates or silicic acid. However, those references do not appear to disclose preventing or reducing scale formation or corrosion by adsorbing to scale crystals a non-aqueous, particulate scale-adsorbent agent, such as calcium silicate.

### SUMMARY OF THE INVENTION

The present inventors have surprisingly found that the addition of particulate anti-scale material comprising an alkaline earth silicate, such as calcium silicate, to at least one laundry detergent may cause the reduction or prevention of scale formation on clothing.

In one embodiment, a laundry detergent composition is provided that comprises: a) at least one particulate alkaline earth silicate having a BET surface area ranging from about 1 m²/g to about 500 m²/g; b) one or more surfactants; and c) optionally other ingredients. In one embodiment, the at least one particulate alkaline earth silicate comprises calcium silicate. In another embodiment, the at least one particulate alkaline earth silicate comprises magnesium silicate. In yet another embodiment the at least one particulate alkaline earth silicate comprises a synthetic silicate material. In yet another embodiment, the synthetic silicate material is derived from diatomaceous earth.

In another embodiment, the laundry detergent comprises at least one particulate scale-adsorbent agent has a BET surface area of from about 5 m²/g to about 500 m²/g, such as for example from about 50 m²/g to about 200 m²/g, from about 100 m²/g to about 200 m²/g, or from about 50 to about 200 m²/g. In another embodiment, the laundry detergent comprises at least one anti-scale material has a median particle size ranging from about 0.1 micron to about 100 microns, such as for example ranging from about 1 micron to about 50 microns, ranging from about 5 microns to about 50 microns, or ranging from about 10 microns to about 30 microns.

In another embodiment, the laundry detergent comprises at least one anti-scale material comprises a calcium silicate having a molar ratio of CaO to SiO₂ ranging from 0.1 to 2.0, such as for example ranging from about 0.4 to about 1.5, ranging from about 0.2 to about 0.6, ranging from about 0.7 to about 1.1, or ranging from about 1.2 to about 1.7.

In yet another embodiment, there is provided a method for treating a fabric article comprising the steps of: a) providing a solution or dispersion of a particulate alkaline earth silicate in a laundry detergent, wherein the particulate alkaline earth metal silicate has a BET surface area ranging from about 1 m²/g to about 500 m²/g, and; b) contacting a fabric article with said solution or dispersion, wherein the treatment occurs during a laundry cleaning process, preferably the main wash of the laundry process.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a scanning electron micrograph showing a cloth surface that is essentially free of scale when treated with the antiscale agent described herein in a hard water (˜5000 mg/L as CaCO₃).

FIG. 2 is a scanning electron micrograph showing calcium carbonate scale formed on the cloth fabric, which can make the cloth stiff and hard. Scale formation is evident on the fabric fiber surfaces.

FIG. 3 is a scanning electron micrograph at 20× magnification showing relatively few scale calcium carbonate particles formed on glass when 0.5 g/L of Sample 5 is added to natural hard water and boiled. The SEM Image shows large scale particles formed on and inside the fabrics of the cloth.

FIG. 4 is a scanning electron micrograph showing microcrystals of calcium carbonate scale (white) adsorbed/attached onto the surfaces of the calcium silicate antiscalant. Thus, the scale formation onto the cloth is prevented

FIG. 5 is a graph showing the dye adsorption effects of selected adsorbents. Diatomaceous earth and silica gels do not adsorb dye pigments, while the synthetic silicates described herein show effective dye adsorption.

FIG. 6A is a pair of scanning electron micrograph (SEM) images showing scale formation on cloth surfaces treated with 0.2 g/L ECOS HE detergent in the absence of calcium silicate antiscalant.

FIG. 6B is a pair of SEM images showing that little or no scale formation occurs on cloth surfaces treated with 0.2 g/L ECOS HE detergent and 0.25 g/L of calcium silicate antiscalant.

FIG. 6C is a pair of SEM images showing that little or no scale formation occurs on cloth surfaces treated with 0.2 g/L ECOS HE detergent and 0.5 g/L of calcium silicate antiscalant.

FIG. 7A is a pair of SEM images showing scale formation on cloth surfaces that have been treated with with 0.2 g/L GAIN HE detergent and no calcium silicate antiscalant.

FIG. 7B is a pair of SEM images showing that little or no scale formation occurs on cloth surfaces treated with 0.2 g/L GAIN HE detergent and 0.25 g/L of calcium silicate antiscalant.

FIG. 7C is a pair of SEM images showing that little or no scale formation occurs on cloth surfaces treated with 0.2 g/L GAIN HE detergent and 0.5 g/L of calcium silicate antiscalant.

FIG. 8A is a pair of SEM images showing scale formation on cloth surfaces treated with 0.6 g/L ECOS HE detergent and no calcium silicate antiscalant.

FIG. 8B is a pair of SEM images showing scale formation occurs on cloth surfaces treated with 0.6 g/L ECOS HE detergent and 0.25 g/L of Zeolite A.

FIG. 8C is a pair of SEM images showing that little or no scale formation occurs on cloth surfaces treated with 0.6 g/L ECOS HE detergent and 0.25 g/L of calcium silicate antiscalant.

FIG. 9A is a pair of SEM images showing scale formation on cloth surfaces treated with 0.7 g/L TIDE Mountain Spring liquid detergent and no calcium silicate antiscalant.

FIG. 9B is a pair of SEM images showing scale formation on cloth surfaces treated with 0.7 g/L TIDE Mountain Spring liquid detergent and 0.25 g/L of Zeolite A.

FIG. 9C is a pair of SEM images showing that little or no scale formation occurs on cloth surfaces treated with 0.7 g/L TIDE Mountain Spring liquid detergent and 0.25 g/L of calcium silicate antiscalant.

FIG. 10A is a pair of SEM images showing scale formation on cloth surfaces treated with 0.6 g/L Ultra TIDE powder detergent and no calcium silicate antiscalant.

FIG. 10B is a pair of SEM images showing that little or no scale formation occurs on cloth surfaces treated with 0.6 g/L Ultra TIDE powdered detergent and 0.5 g/L of calcium silicate antiscalant.

FIG. 11A is a pair of SEM images showing scale formation on cloth surfaces treated with 0.6 g/L Ultra TIDE powdered detergent and no of calcium silicate antiscalant.

FIG. 11B is a pair of SEM images showing reduced scale formation on cloth surfaces treated with 0.6 g/L Ultra TIDE powdered detergent and 0.5 g/L of calcium silicate antiscalant.

FIG. 12A is a pair of SEM images showing scale formation on cloth surfaces treated with 0.68 g/L TIDE Mountain Spring liquid detergent and no calcium silicate antiscalant.

FIG. 12B is a pair of SEM images showing reduced scale formation on cloth surfaces treated with 0.68 g/L TIDE Mountain Spring liquid detergent and 0.5 g/L calcium silicate antiscalant.

FIG. 12C is as SEM image showing scale formation on a glass surface treated with 0.68 g/L TIDE Mountain Spring liquid detergent and no calcium silicate antiscalant.

FIG. 12D is as SEM image showing reduced scale formation on a glass surface treated with 0.68 g/L TIDE Mountain Spring liquid detergent and 0.5 g/L calcium silicate antiscalant.

FIG. 13A is a pair of SEM images showing scale formation on cloth surfaces treated with 0.6 g/L GAIN liquid detergent and no calcium silicate antiscalant.

FIG. 13B is a pair of SEM images showing reduced scale formation on cloth surfaces treated with 0.6 g/L GAIN liquid detergent and 0.25 g/L calcium silicate antiscalant.

### DETAILED DESCRIPTION OF THE INVENTION

The descaling and anti-corrosion methods described herein generally involve dispersion by adsorption. In one embodiment, and without wishing to be bound by theory, natural or synthetic particulate materials may adsorb the nucleation centers or microcrystal seeds of scale molecules, dispersing the growing scale crystals onto the materials, which provide a high surface area. The materials may remain suspended in the at least one scale-forming fluid, so that scale deposit on the equipment surfaces can be prevented or minimized. Unlike the dispersion function of the specialty anti-scalant chemicals, which modify the surface charges of scaling microcrystals, the adsorption mechanisms described herein generally use at least one adsorbent agent to carry away and disperse the nucleation centers or microcrystals of at least one scaling compound, so that scale deposits onto equipment surfaces can be avoided.

In one embodiment, a particulate natural adsorbent, such as diatomaceous earth, or powdered synthetic silicates, such as calcium silicates, are used as microcrystal adsorbents or carriers.

### Anti-Scale Material

The methods disclosed herein incorporating at least one anti-scale material into a laundry detergent. The anti-scale material may be added to the laundry detergent in a substantially dry form, including but not limited to granules, pellets, flakes, particles, and powder, or may be introduced as a slurry. In one embodiment, the at least one anti-scale material is only partially soluble, or insoluble, in water. In yet another embodiment, the at least one anti-scale material is inorganic. In yet a further embodiment, the at least one anti-scale material is stable (e.g., does not dissolve) under the conditions (e.g., pressure, temperature, flow rate, turbulence) present in a typical laundry system. In another embodiment, the at least one anti-scale material has an affinity for at least one scale-forming compound, for example due to electrical charge and/or chemical reactivity. In a further embodiment, the at least one anti-scale material does not corrode or otherwise negatively impact the surface and/or structural integrity of the laundry system. In yet another embodiment, the at least one anti-scale material forms a suspension when added to the at least laundry wash water.

In one embodiment, the at least one anti-scale material is at least one scale-adsorbent agent. Scale-adsorbent agents may adsorb one or more scale-forming compounds present in the at least one scale-forming fluid, thus reducing or preventing the formation of scale on a surface of the at least one fluid handling system. In one embodiment, the at least one scale-adsorbent agent is a silicate material. Exemplary silicate materials include, but are not limited to, natural silicates (such as, for example, calcium silicate (e.g., wollastonite)) and synthetic silicate (such as, for example, silica gel). In another embodiment, the at least one scale-adsorbent agent is calcium silicate. Exemplary calcium silicates include, but are not limited to, amorphous calcium silicates, tobermorite, xonotlite, foshagite, riversideite, pseudowollastonite, and gyrolite. In a further embodiment, the at least one scale-adsorbent agent is a mineral material. Exemplary mineral materials include, but are not limited to, diatomaceous earth (also called “DE” or “diatomite”) and kaolin clay. The DE may be from one or more sources, including fresh water and salt water sources. In yet another embodiment, the at least one scale-adsorbent agent is a cellulose powder. In yet a further embodiment, the at least one scale-adsorbent agent is vermiculite. In still another embodiment, the at least one scale-adsorbent agent is powdered calcium silicate and/or magnesium silicate, derived from diatomaceous earth.

In another embodiment, the at least one anti-scale agent can include a calcium silicate having a molar ratio of CaO to SiO₂ ranging from 0.1 to 2.0, such as for example ranging from about 0.4 to about 1.5, ranging from about 0.2 to about 0.6, ranging from about 0.7 to about 1.1, or ranging from about 1.2 to about 1.7.

In one embodiment, the at least one anti-scale material includes composite particles. Scale-adsorbent agents may be provided as a coating on a particulate substrate. For example, the scale adsorbent agent may be precipitated onto a low density substrate, such as expanded perlite or polymer, thus to reduce the density of the anti-scale material and enhance the suspension in liquid. In another embodiment, the scale adsorbent may be precipitated onto a hollow substrate, such as for example a polymeric, glass, or ceramic, microsphere. It is envisioned that in one embodiment, use of such a hollow substrate could be used to control the buoyancy of the anti-scale material, and even to match the buoyancy of the anti-scale material to that of the scale-forming fluid.

In general, the at least one anti-scale material has a BET specific surface areas ranging from about 1 m²/g to about 500 m²/g. In another embodiment, the BET surface area ranges from about 50 m²/g to about 200 m²/g. In a further embodiment, the BET surface area ranges from about 100 m²/g to about 200 m²/g. One of ordinary skill in the art will readily understand appropriate methods and devices capable of measuring the BET surface area of an at least one anti-scale material. BET surface area of a powdered material may be measured, for example, by a Gemini III 2375 Surface Area Analyzer, which uses pure nitrogen as the sorbent gas, available from Micromeritics Corporation.

In general, the at least one anti-scale material has a water absorption ranging from about 200% to about 1000%. In another embodiment, the water absorption ranges from about 200% to about 600%.

In general, the at least one anti-scale material can have a median particle size ranging from 0.1 microns to about 100 microns or more (as measured by Microtrac). For example, in one embodiment, the at least one anti-scale material has a median particle size ranging from about 1 micron to about 50 microns. In another embodiment, the at least one anti-scale material has a median particle size ranging from about 5 microns to about 30 microns. In another embodiment, the at least one anti-scale material has a median particle size ranging from about 10 microns to about 30 microns. In a further embodiment, the median particle size is about 20 microns. One of ordinary skill in the art will readily understand that the particle size distribution may be quantified by determining the difference in particle size distribution between the components. One method employs a laser diffraction instrument, for example, a Leeds & Northrup Microtrac Model X-100. That instrument is fully automated, and the results are obtained using a volume distribution formatted in geometric progression of 100 channels, running for 30 seconds with the filter on. The distribution is characterized using an algorithm to interpret data characterized by a diameter, d. The d₅₀ value of the sample may be identified by the instrument.

The at least one anti-scale material may, in some embodiments, adsorb one or more species or particles of the at least one scale-forming compound, such that the interaction is greater than stoichiometric. In one embodiment, the at least one anti-scale material may adsorb crystals or other nucleated structures of scale formed by an at least one scaling compound. In still another embodiment, the at least one anti-scale material shows affinity toward at least one scale-forming compound.

The at least one anti-scale precursor compound may be provided as a solution, slurry, granules, pellets, flakes, particles, and powder.

The at least one anti-scale material may be introduced to the laundry detergent in an amount sufficient to result in a desired concentration in the laundry washwater. In one embodiment, the added amount of at least one anti-scale material is sufficient to result in concentration in the wash water of about 0.01 g/L to about 20 g/L. In another embodiment, the added amount of at least one anti-scale material is sufficient to result in concentration in the wash water of about 0.01 g/L to about 10 g/L. In another embodiment, the added amount of at least one anti-scale material is sufficient to result in concentration in the wash water of about 0.01 g/L to about 5 g/L. In another embodiment, the added amount of at least one anti-scale material is sufficient to result in concentration in the wash water of about 0.01 g/L to about 2 g/L. In another embodiment, the added amount is sufficient to result in concentration in the wash water of about 0.05 g/L to about 0.5 g/L. In a further embodiment, the added amount is sufficient to result in concentration in the wash water of greater than or equal to about 0.01 g/L. In yet another embodiment, the added amount is sufficient to result in concentration in the wash water of about 0.05 g/L. In yet a further embodiment, the added amount is sufficient to result in concentration in the wash water of about 0.1 g/L. In still another embodiment, the added amount is sufficient to result in concentration in the wash water of about 0.25 g/L. In still a further embodiment, the added amount is sufficient to result in concentration in the wash water of about 0.5 g/L.

An at least one scale-adsorbent agent may exhibit one or more conventional anti-scaling effects in addition to adsorption. In one embodiment, the at least one anti-scale material is also a precipitation threshold inhibitor. In another embodiment, the at least one anti-scale material is also a dispersant. In a further embodiment, the at least one anti-scale material is also a crystal distortion/modification chemical.

In addition to preventing scale, the anti-scale material may also be useful to adsorb fugitive dye particles from the laundry wash water to prevent clothing discoloration caused when fugitive dyes reassociate with clothing.

In addition to preventing scale, the anti-scale material may also be useful to moderate one or more chemical characteristics of a liquid. For example, in one embodiment the anti-scale material may be used to moderate the hardness of a liquid. In another embodiment, the anti-scale material may be used to moderate the total dissolved solids of a liquid. In yet another embodiment, the anti-scale material may be used to moderate the alkalinity of a liquid.

In a further embodiment, the adsorbed scale material is discharged to the environment along with the wash water, after the at least one scale-forming fluid has been used in the laundry system. In another embodiment, the adsorbed or attached scale material can be collected on a filter pad, sieve screen or honeycomb filter or other frame of grid media made of at least one anti-scale adsorbent can be detached and the media can be reused in scale-forming liquid.

### Other Detergent Ingredients

### Surfactant

The surfactant, or detergent-active compound present in the surfactant base may be present as a single surfactant, or as two or more surfactants. The term surfactant should be construed herein as encompassing a single surfactant or a mixture of two or more surfactants.

Detergent-active compounds (surfactants) may be chosen from soap and non-soap anionic, cationic, non-ionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch. The preferred detergent-active compounds that can be used are soaps and synthetic non-soap anionic and non-ionic compounds. The total amount of surfactant present is suitably within the range of from 5 to 60 wt. %, preferably from 5 to 40 wt. %.

Anionic surfactants are well-known to those skilled in the art. Examples include alkylbenzene sulphonates, particularly linear alkylbenzene sulphonates having an alkyl chain length of C8-C15; primary and secondary alkylsulphates, particularly C8-C20 primary alkyl sulphates; alkyl ether sulphates; olefin sulphonates; alkyl xylene sulphonates; dialkyl sulphosuccinates; and fatty acid ester sulphonates. Sodium salts are generally preferred.

Non-ionic surfactants that may be used include the primary and secondary alcohol ethoxylates, especially the C8-C20 aliphatic alcohols ethoxylated with an average of from 1 to 20 moles of ethylene oxide per mole of alcohol, and more especially the C10-C15 primary and secondary aliphatic alcohols ethoxylated with an average of from 1 to 10 moles of ethylene oxide per mole of alcohol. Non-ethoxylated non-ionic surfactants include alkylpolyglycosides, glycerol monoethers, and polyhydroxyamides (glucamide).

Cationic surfactants that may be used include quaternary ammonium salts of the general formula R1R2R3R4N+X− wherein the R groups are long or short hydrocarbyl chains, typically alkyl, hydroxyalkyl or ethoxylated alkyl groups, and X is a solubilising anion (for example, compounds in which R1 is a C8-C22alkyl group, preferably a C8-C10 or C12-C14 alkyl group, R2 is a methyl group, and R3 and R4, which may be the same or different, are methyl or hydroxyethyl groups); and cationic esters (for example, choline esters).

According to a preferred embodiment of the invention, the composition comprises a sulphonate anionic surfactant and/or a primary alcohol sulfate surfactant.

According to an especially preferred embodiment, the sulphonate anionic surfactant comprises linear alkylbenzene sulphonate (LAS) and/or primary alcohol sulfate (PAS).

In a preferred embodiment, the surfactant base comprises at least an anionic surfactant and a non-ionic surfactant. Even more preferred is a surfactant base comprising an anionic, non-ionic and amphoteric or zwitterionic surfactant.

Preferred non-ionic surfactants are the primary and secondary alcohol ethoxylates.

Preferred amphoteric or zwitterionic surfactants are amine oxides and betaines, especially carbobetaines and sulfobetaines. An example of one such surfactant is lauryl betaine.

The surfactants are generally present in the final formulations at a level of from 1 to 80% by weight of the total formulation, preferably from 2 to 60%, more preferably from 5 to 60% and most preferably from 5 to 40% by weight of total formulation.

The laundry detergent composition of the present invention utilises the polyaspartate derivative defined herein for laundry cleaning purposes. The laundry detergent composition comprising the polyaspartate derivative has been found to be active for oily soil removal and particulate soil removal. Accordingly the invention also relates to the use of the polyaspartate derivative in a laundry detergent composition, the use of the polyaspartate derivative in a laundry composition for the removal of particulate soil, and the use of the polyaspartate derivative in a laundry composition for the removal of oily soil.

### Other Detergent Ingredients

The laundry detergent composition can also comprise other detergent ingredients well known in the art. These may suitably be selected from bleach ingredients, enzymes (proteases, lipases, amylases and cellulases); inorganic salts such as sodium carbonate, sodium silicate and sodium sulphate, antiredeposition agents such as cellulosic polymers; foam controllers, foam boosters, perfumes, fabric conditioners, soil release polymers, dye transfer inhibitors, photobleaches, fluorescers and coloured speckles. This list is not intended to be exhaustive. Detergent compositions according to the invention may also suitably contain bleach, such as for example peroxy bleach compound such as an inorganic persalt or an organic peroxyacid, capable of yielding hydrogen peroxide in aqueous solution. Preferred inorganic persalts are sodium perborate monohydrate and tetrahydrate, and sodium percarbonate, the latter being especially preferred. The sodium percarbonate may have a protective coating against destabilisation by moisture. The peroxy bleach compound is suitably present in an amount of from 5 to 35 wt. %, preferably from 10 to 25 wt. %.

The peroxy bleach compound may be used in conjunction with a bleach activator (bleach precursor) to improve bleaching action at low wash temperatures. The bleach precursor is suitably present in an amount of from 1 to 8 wt. %, preferably from 2 to 5 wt. %. Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA), diethylenetriamine pentaacetate (DTPA), ethylenediamine disuccinate (EDDS), and the polyphosphonates such as the Dequests (Trade Mark), ethylenediamine tetramethylene phosphonate (EDTMP) and diethylenetriamine pentamethylene phosphate (DETPMP).

The compositions of the invention may contain alkali metal, preferably sodium, carbonate, in order to increase detergency and ease processing. Sodium carbonate may suitably be present in amounts ranging from 1 to 60 wt. %, preferably from 2 to 40 wt. %.

Powder flow may be improved by the incorporation of a small amount of a powder structurant. Examples of powder structurants, some of which may play other roles in the formulation as previously indicated, include, for example, fatty acids (or fatty acid soaps), sugars, acrylate or acrylate/maleate polymers, sodium silicate, and dicarboxylic acids (for example, Sokalan (Trade Mark) DCS ex BASF). One preferred powder structurant is fatty acid soap, suitably present in an amount of from 1 to 5 wt. %.

The compositions of the invention may be in any physical form e.g. a solid such as a powder or granules, a tablet, a solid bar, a paste, gel or liquid, especially, an aqueous based liquid. In many of these compositions, particularly non-liquid formulations, detergent builder may be required as a necessary component of the composition. Where such a requirement exists the builder is preferably incorporated at a level of from 0 to 30% by weight of total formulation.

In addition to the aforementioned surfactants, the laundry detergent compositions of the invention may contain additional surface-active compound (surfactant) which may be chosen from soap and non-soap anionic, cationic, non-ionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

The invention further relates to a method for treating a fabric article comprising the steps of: a) providing a solution or dispersion of a particulate alkaline earth silicate in a laundry detergent, wherein the particulate alkaline earth metal silicate has a BET surface area ranging from about 1 m²/g to about 500 m²/g, and; b) contacting a fabric article with said solution or dispersion, wherein the treatment occurs during a laundry cleaning process, preferably the main wash of the laundry process.

The fabric article can be any fabric textile article, preferably it is a non-keratinaceous textile such as cotton or polyester. The laundry detergent composition of the invention is preferably a main wash detergent for use in the main wash cycle of machines or in the hand-wash, and so preferably the contacting of the fabric article occurs during the main wash or hand wash.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations and, unless otherwise indicated, the numerical values set forth in the specific examples are reported as precisely as possible. Any numerical value, however, inherently contains certain errors necessarily resulting from the standard deviation found in their respective testing measurements.

By way of non-limiting illustration, examples of certain embodiments of the present disclosure are given below.

### EXAMPLES

The laboratory anti-scaling experiments were generally performed as follows. A given amount of the antiscaling material was mixed into 1000 ml of hard water with an initial hardness of about 600 ppm CaCO₃. The resulting suspension was heated on a hot plate and allowed to evaporate until about 100 ml of water was left. The scale formed on the surfaces of an inserted material, such as a glass or a metal, was then examined.

In the fabric antiscaling experiments, several small pieces of cloth were placed in each beaker and different dosages of a detergent was either mixed in the hard water or placed in the evaporation beakers. In addition, a blank control was prepared, where only the detergent was added. The test samples that have the same amount of detergent but different loadings of the calcium silicate antiscalant were evaporated and the scales formed on the inserted cloths were examined under a Philips XL30 SEM/EDS.

In each of the below examples, the antiscalant material used was a diatomite derived synthetic calcium silicate having a median particle size of about 18 microns, a loss weight of about 5.4 lbs/ft³, a BET surface area of about 120 m²/g, and a water absorption of about 550% by weight. The choice of calcium silicate as an adsorbent in the examples should not be construed as limiting, as other alkaline earth metal silicates are also expected to provide acceptable results.

### Example 1

The anti-scaling effects of adsorbent for the prevention of scale on fabrics and for the adsorption of fugitive dyes during washing process or dye removal from waste water. The use of the antiscale agent as an adsorbent appears also protect the colors and surfaces of the fabric since the adhesive scale formation is prevented.

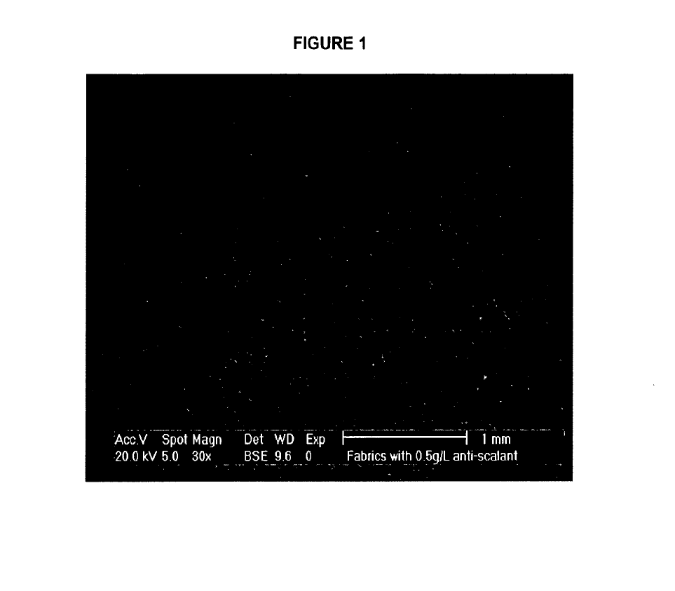

In each case, 0.25 g to 0.5 g of the powdered calcium silicate antiscalant material were mixed into 1000 ml of a hard water with an initial hardness of about 600 ppm CaCO₃. The water was evaporated on a hotplate until about 100 ml of water remained. In the fabric antiscaling experiments, several small pieces of cloth were placed in each beaker, and the scales formed on the inserted cloths were examined. Table 1 shows the results. SEM images are shown in FIGS. 1-3.

TABLE 1
Fabric Antiscaling Tests with Calcium Silicate Antiscalant.

| | Water | | Evaporated | Scaling | |
|---|---|---|---|---|---|
| | Volume | Loading | water | on Fabric | Color of |
| Sample ID | (ml) | (g) | (ml) | (%)* | Water |
| Control | 1000 | NA | 900 | 100 | colored |
| Water | | | | | |
| CS | 1000 | 0.25 | 900 | 0 | clear |
| Antiscalant | | | | | |
| CS | 1000 | 0.5 | 900 | 0 | clean |
| Antiscalant | | | | | |

*Scaling is ranked from 100% to 0%, with 100% as the most severe scaling and 0% as no scaling.

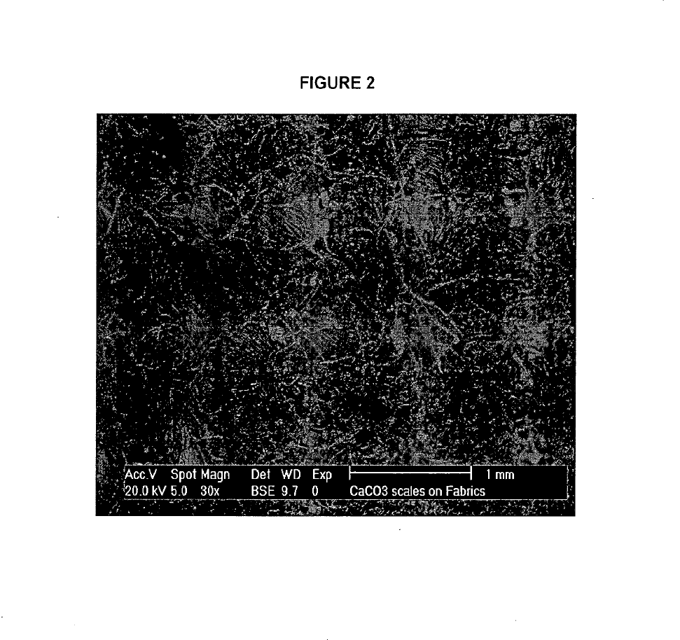

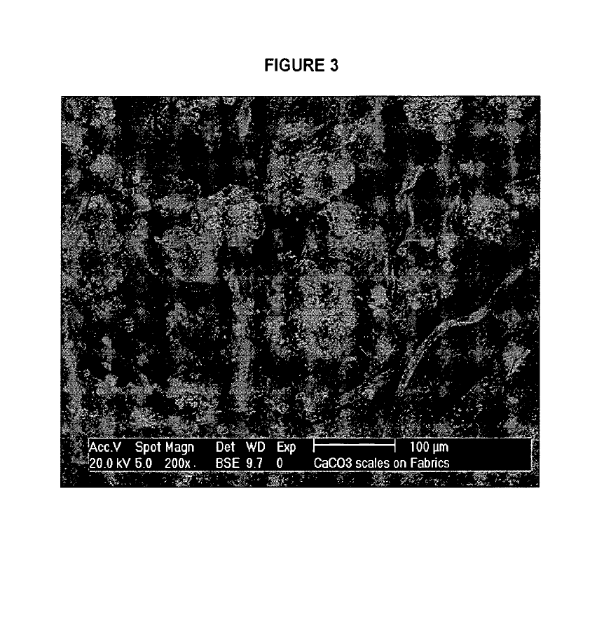

As shown in Table 1, in laboratory fabric scaling prevention experiments, the calcium carbonate scale is prevented from forming on clothes by using the calcium silicate antiscalant (FIG. 1), while on the fabrics in the control (no anti-scalant was used), abundant calcium carbonate scale was formed (see FIG. 2 and FIG. 3). Cloth treated with the calcium silicate antiscalant is soft and free from scale, while the cloth in the control became stiff and hard due to scale formation on the surfaces and the inside of the fabrics. The scale adheres to the fabric fibers, and to its removal could cause surface damages and decoloring.

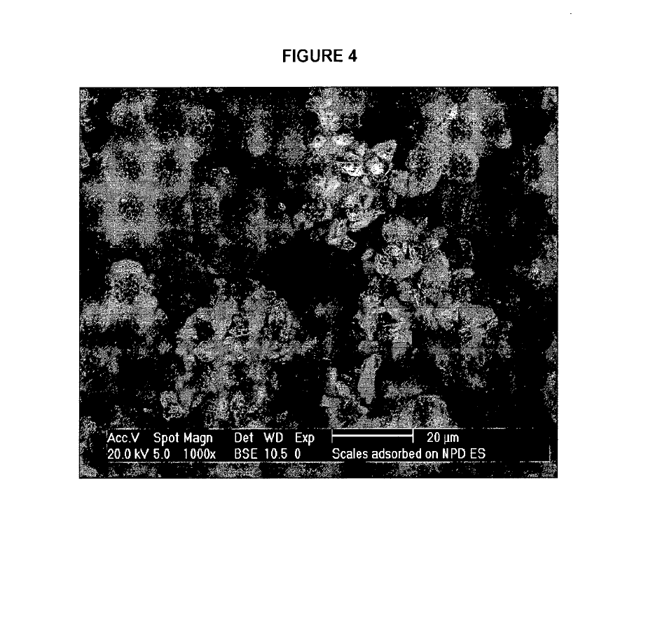

FIG. 4 is an SEM image that shows adhesion of scale crystals to the calcium silicate antiscalant.

It was also noted that the residue water in the control beaker became colored due to the decoloring of the fabric under testing, while in the beakers with the silicate antiscalant, the water is clear due to the adsorption of the fugitive dyes by the silicate adsorbent.

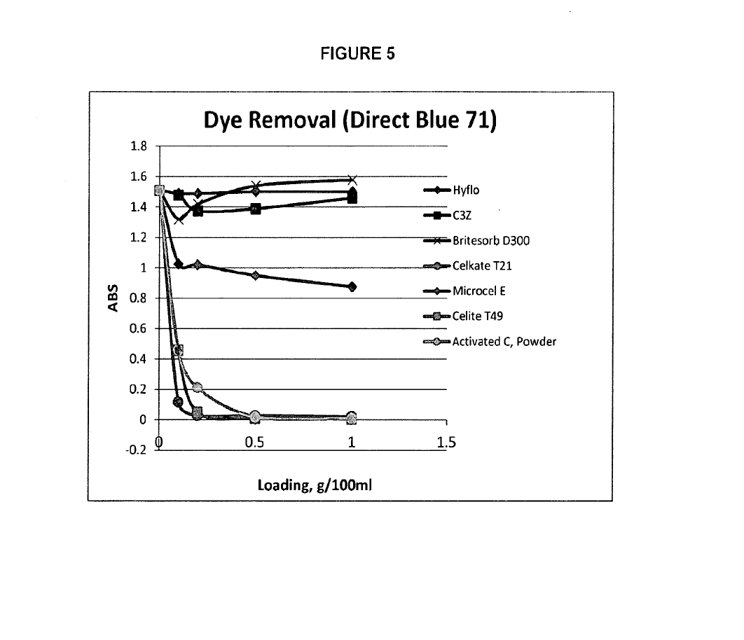

In separated dye adsorption experiments, we investigated the dye adsorption effects of our synthetic silicates (see FIG. 5). In some cases, the calcium silicate antiscalant proved as effective or better than powdered activated carbon control.

These results show that use of a calcium silicate antiscalant in fabric washing processes can prevent scale formation on cloth surfaces and fibers, and can adsorb fugitive color pigments, thus helping in water discharge and treatment. It is also notable that the calcium silicate antiscalant is stable under a variety of processing conditions and can even be used at high temperatures and pressures. The calcium silicate antiscalant can also act as a solid buffer agent to control the hardness and alkalinity of the water, even at high cycle of concentrations with extremely high hardness. In addition to its anti-scaling properties, the product could also potentially be used as a sustained release agent for different class of compounds (for example, as a delayed release scent carrier) or as an anti-caking or thickening agent in detergent.

### Example 2

### Antiscaling Tests with ECOS 2X Ultra HE Liquid Detergent

0.20 g of the EGOS HE detergent was weighed into each of the three 1000-mL glass bottles. One bottle was kept as the blank control in which no antiscalant was added. In the other two bottles, 0.25 g and 0.5 g of calcium silicate antiscalant were added respectively, and mixed well. Fabric samples were added to each bottle.

The three labeled 250-mL stainless steel beakers were placed on a hotplate and evaporate the water content of each bottle until ˜100 ml liquid left.

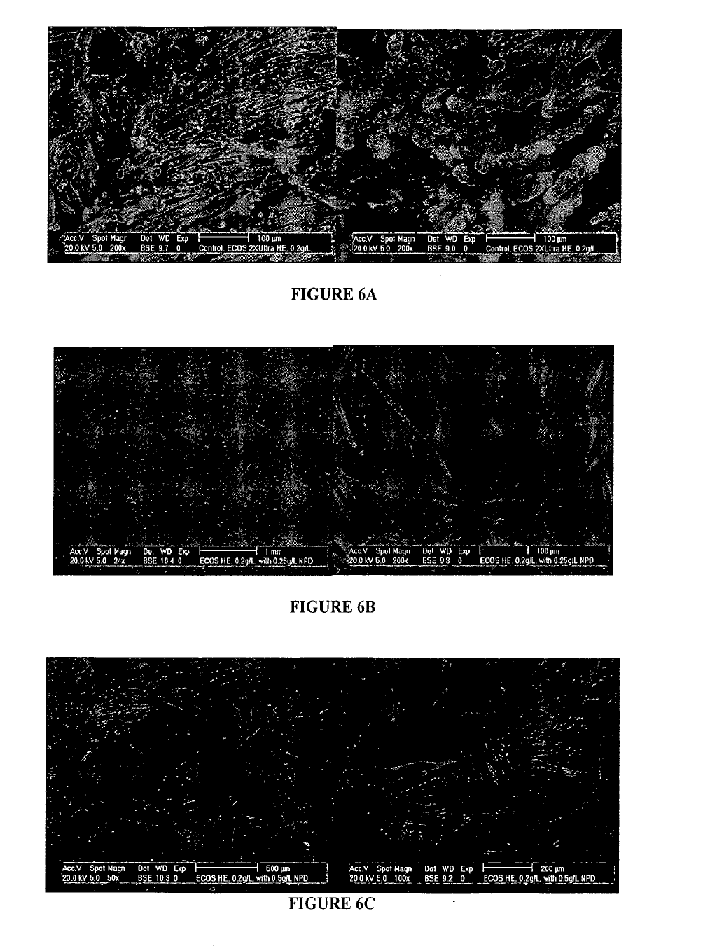

Table 2 shows the results. SEM images of the fabric samples are shown in the FIGS. 6A-6C.

TABLE 2
Fabric Antiscaling Tests with ECOS HE Detergent
and Calcium Silicate Antiscalant.

| | Detergent | Original Water | | Residue Water | | |
|---|---|---|---|---|---|---|
| | added | | Cond. | | Cond. | |
| Sample ID | (g/L) | pH | (uS/cm) | pH | (mS/cm) | Comments |
| 0 CS | 0.20 | 6.8 | 980 | 8.19 | 4.47 | Fabric |
| Control | | | | | | became |
| | | | | | | stiff and |
| | | | | | | scale |
| | | | | | | formed on |
| | | | | | | fabric |
| 0.25 g CS | 0.20 | 6.8 | 980 | 7.90 | 4.26 | Fabric was |
| Antiscalant | | | | | | soft with |
| | | | | | | little or |
| | | | | | | no scale |
| 0.5 g CS | 0.20 | 6.8 | 980 | 8.12 | 4.10 | Fabric was |
| Antiscalant | | | | | | soft with |
| | | | | | | little or |
| | | | | | | no scale |

### Example 3

### Antiscaling Tests with GAIN HE Liquid Detergent

0.20 g of GAIN HE detergent was weighed into each of the three 1000-mL glass bottles. One bottle was kept as the blank control in which no calcium silicate antiscalant was added. In the other two bottles, 0.25 g and 0.5 g of calcium silicate antiscalant were added respectively, and mixed well. Fabric samples were added to each bottle.

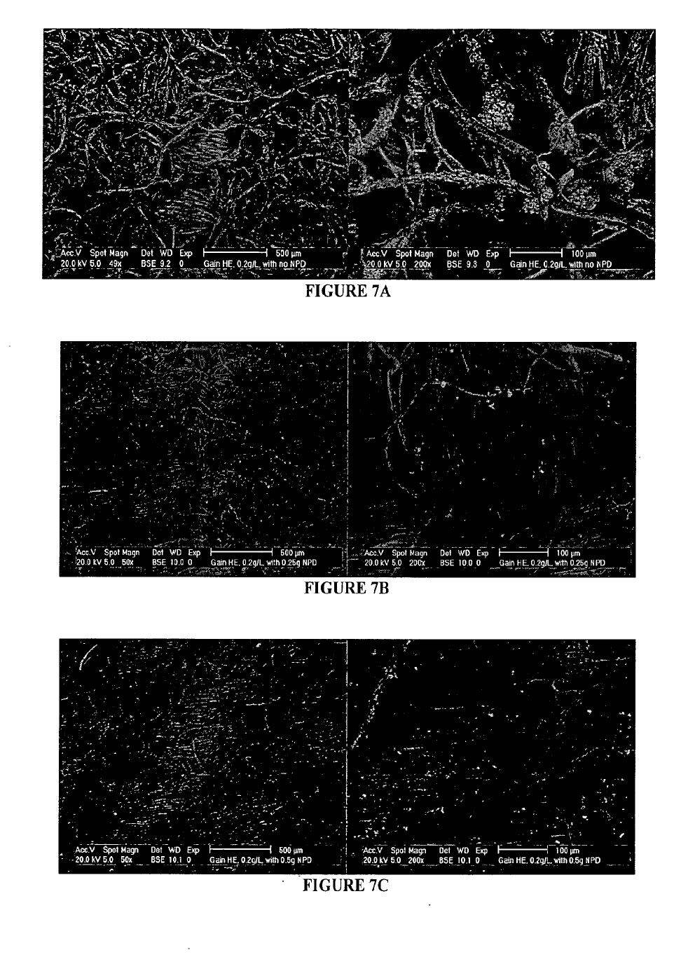

The three labeled 250-mL stainless steel beakers were placed on a hotplate and heated to evaporate the water content of each bottle until ˜100 ml liquid was left. Table 3 shows the results. SEM images of the fabric samples are shown in the FIGS. 7A-7C.

TABLE 3
Fabric Antiscaling Tests with Calcium Silicate Antiscalant.

| | Detergent | Original Water | | Residue Water | | |
|---|---|---|---|---|---|---|
| | added | | Cond. | | Cond. | |
| Sample ID | (g/L) | pH | (uS/cm) | pH | (mS/cm) | Comments |
| 0 CS | 0.20 | 6.9 | 970 | 8.43 | 4.74 | Fabric |
| Control | | | | | | became |
| | | | | | | stiff and |
| | | | | | | scales |
| | | | | | | formed on |
| | | | | | | fabrics |
| 0.25 g CS | 0.21 | 6.9 | 970 | 8.44 | 4.38 | Fabric is |
| Antiscalant | | | | | | soft with |
| | | | | | | less scales |
| 0.5 g CS | 0.21 | 6.9 | 970 | 8.30 | 4.61 | Fabric is |
| Antiscalant | | | | | | soft with |
| | | | | | | less scales |

### Example 4

### Calcium Silicate Antiscalant Compared to Zeolite A (Control)

Weighed 0.60 g of the ECOS HE detergent into each of the three 1000-mL glass bottles. One bottle was kept as the blank control in which no antiscalant was added. In the other two bottles, 0.25 g Zeolite A and 0.25 g of the calcium silicate antiscalant were added respectively, and mixed well.

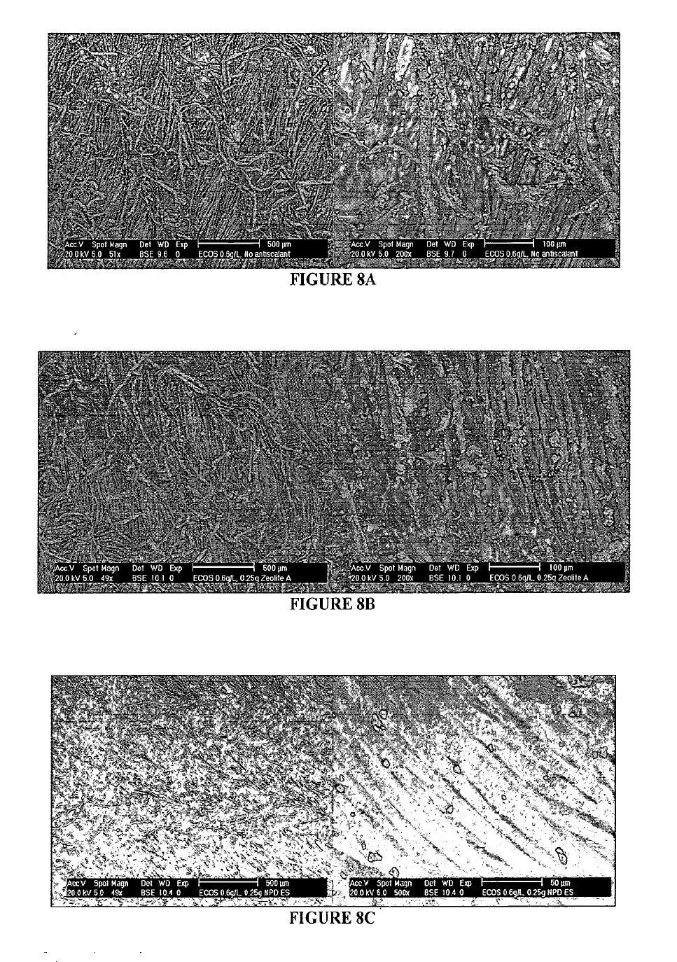

Placed three labeled 250-mL stainless steel beakers on a hotplate and evaporate the water content of each bottle until ˜100 ml liquid left. Table 3 shows the results. SEM images of the fabric samples are shown in the FIGS. 8A-8C.

TABLE 4
Fabric Antiscaling Tests with Calcium
silicate Antiscalant and Zeolite A.

| | Detergent | Original Water | | Residue Water | | |
|---|---|---|---|---|---|---|
| | added | | Cond. | | Cond. | |
| Sample ID | (g/L) | pH | (uS/cm) | pH | (mS/cm) | Comments |
| 0 CS | 0.60 | 6.9 | 872 | 8.40 | 4.83 | Fabric |
| Control | | | | | | coated |
| | | | | | | with solids |
| | | | | | | and scales |
| | | | | | | formed on |
| | | | | | | fabrics |
| 0.25 g CS | 0.60 | 6.9 | 872 | 8.46 | 4.56 | Fabric is |
| Antiscalant | | | | | | soft with |
| | | | | | | little |
| | | | | | | scales |
| 0.25 g | 0.60 | 6.9 | 872 | 8.67 | 4.68 | Fabric |
| Zeolite A | | | | | | coated |
| | | | | | | with solids |
| | | | | | | and scales |
| | | | | | | formed on |
| | | | | | | fabrics |

### Example 5

### Calcium Silicate Antiscalant Compared to Zeolite A (Control)

Weighed 0.70 g of the TIDE Mountain Spring Liquid Detergent into each of the three 1000-mL glass bottles. One bottle was kept as the blank control in which no calcium silicate antiscalant was added. In the other two bottles, 0.25 g Zeolite A and 0.25 g of the calcium silicate antiscalant were added respectively, and mixed well.

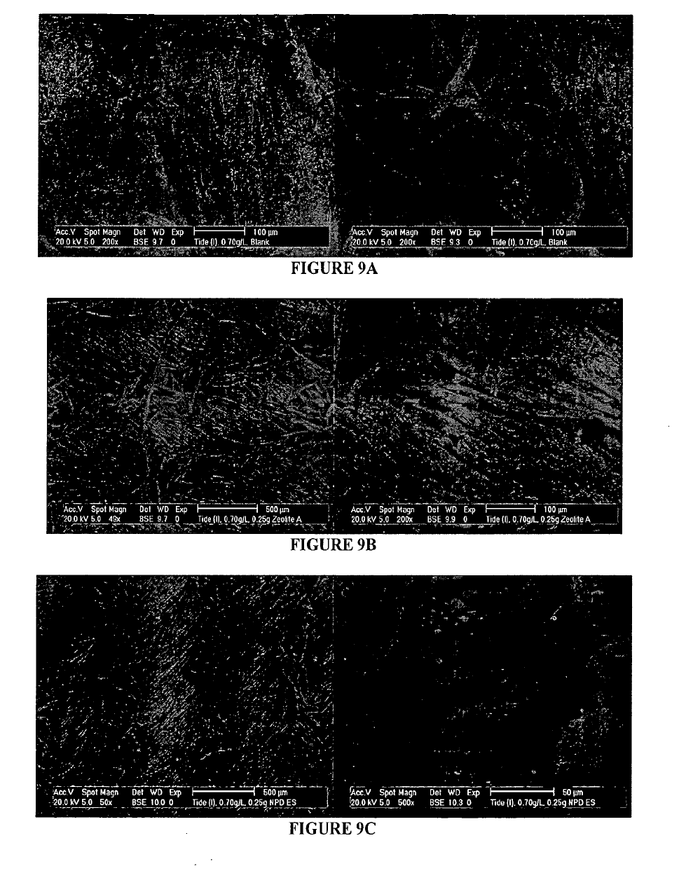

Placed three labeled 250-mL stainless steel beakers on a hotplate and evaporate the water content of each bottle until ˜100 ml liquid left. Table 5 shows the results. SEM images of the fabric samples are shown in the FIGS. 9A-9C.

TABLE 5
Fabric Antiscaling Tests with TIDE Maintain
Spring Detergent and Zeolite A.

| | Detergent | Original Water | | Residue Water | | |
|---|---|---|---|---|---|---|
| | added | | Cond. | | Cond. | |
| Sample ID | (g/L) | pH | (uS/cm) | pH | (mS/cm) | Comments |
| 0 CS | 0.70 | 7.0 | 958 | 8.9 | 4.31 | Fabric |
| Control | | | | | | coated |
| | | | | | | with solids, |
| | | | | | | scales |
| | | | | | | formed on |
| | | | | | | the fabric |
| 0.25 g CS | 0.69 | 7.0 | 958 | 8.8 | 4.21 | Fabric with |
| Antiscalant | | | | | | less solids/ |
| | | | | | | scales |
| 0.25 g | 0.70 | 7.0 | 958 | 9.0 | 4.98 | Fabric with |
| ZeoliteA | | | | | | less solids/ |
| | | | | | | scales |

### Example 6

### Antiscaling Tests with Ultra TIDE Powdered Detergent

Weighed 0.60 g of the Ultra TIDE powder detergent into each of the three 1000-mL glass bottles. One bottle was kept as the blank control in which no calcium silicate antiscalant was added. In the other two bottles, 0.25 g and 0.50 g of the antiscalant were added respectively, and mixed well.

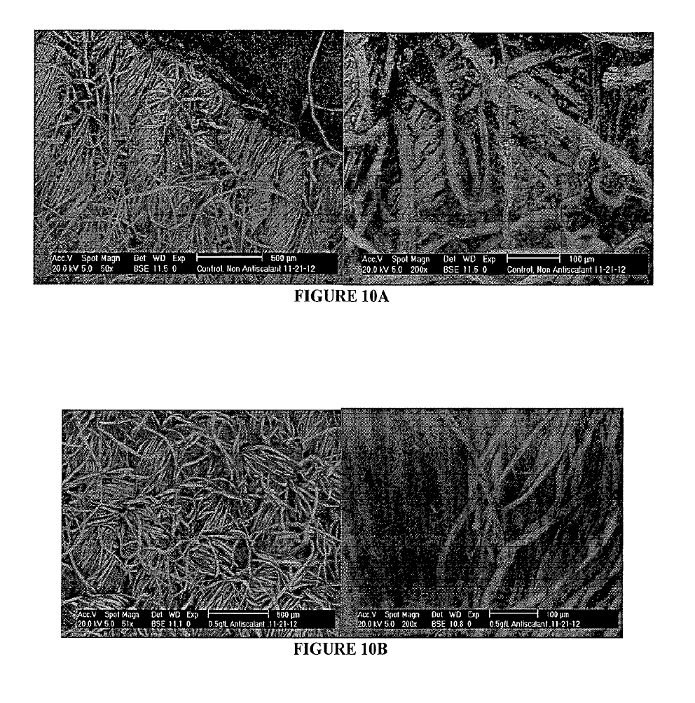

Placed three labeled 250-mL stainless steel beakers on a hotplate and evaporate the water content of each bottle until ˜100 ml liquid left. SEM images of the fabric samples are shown in the FIGS. 10A-10C.

TABLE 6
Fabric Antiscaling Tests with Ultra TIDE Powdered Detergent.

| | Detergent | Original Water | | Residue Water | | |
|---|---|---|---|---|---|---|
| | added | | Cond. | | Cond. | |
| Sample ID | (g/L) | pH | (mS/cm) | pH | (mS/cm) | Comments |
| 0 CS | 0.60 | 6.7 | 1.02 | 8.90 | 8.34 | Fabric |
| Control | | | | | | became |
| | | | | | | stiff and |
| | | | | | | scales |
| | | | | | | “coated” |
| | | | | | | the fabric |
| 0.25 g CS | 0.60 | 6.7 | 1.02 | 8.96 | 8.06 | Fabric is |
| Antiscalant | | | | | | softer with |
| | | | | | | less scales |
| 0.5 g CS | 0.60 | 6.7 | 1.02 | 9.21 | 7.82 | Fabric is |
| Antiscalant | | | | | | softer with |
| | | | | | | less scales |

### Example 7

### Antiscaling Tests with TIDE Maintain Spring Liquid Detergent

Weighed ˜0.61 g of the Ultra TIDE powder detergent into each of the three 250-mL stainless beakers. One beaker was kept as the blank control in which no Calcium silicate antiscalant was added. In the other two bottles, 0.25 g and 0.5 g of the antiscalant were added, respectively, and mixed well.

Placed three labeled 250-mL stainless steel beakers on a hotplate and add and to make up the evaporated volume with 1000 ml of the hard water, evaporate the water content of each beaker until ˜100 ml liquid left.

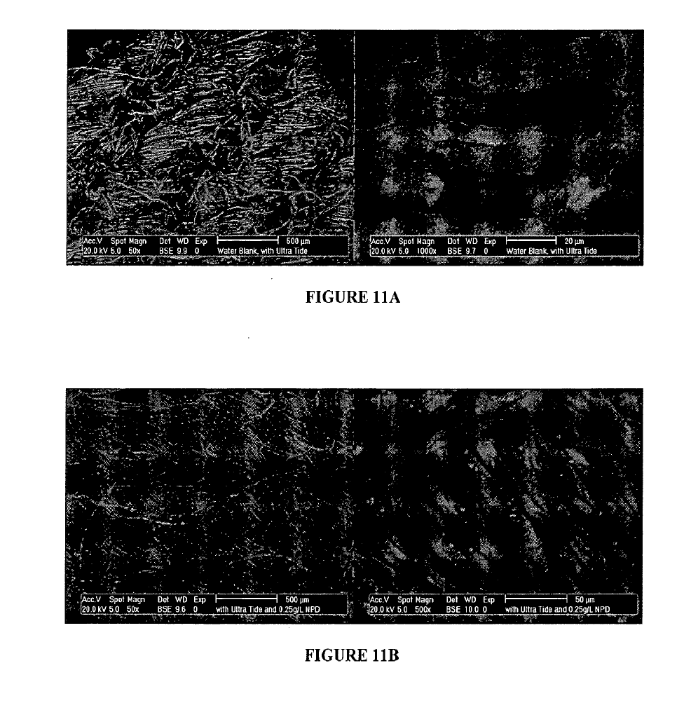

Table 7 shows the results. SEM images of the fabric samples are shown in the FIGS. 11A-11C.

TABLE 7
Fabric Antiscaling Tests with Ultra TIDE Powder Detergent.

| | Detergent | Original Water | | Residue Water | | |
|---|---|---|---|---|---|---|
| | added | | Cond. | | Cond. | |
| Sample ID | (g/L) | pH | (mS/cm) | pH | (mS/cm) | Comments |
| 0 CS | 0.61 | 6.9 | 1.06 | 8.70 | 13.1 | Fabric |
| Control | | | | | | became |
| | | | | | | hard and |
| | | | | | | scales |
| | | | | | | “coated” |
| | | | | | | the fabric |
| 0.25 g CS | 0.61 | 6.9 | 1.06 | 8.95 | 9.76 | Fabric is |
| Antiscalant | | | | | | softer with |
| | | | | | | less scales |
| 0.5 g CS | 0.61 | 6.9 | 1.06 | 8.92 | 9.97 | Fabric is |
| Antiscalant | | | | | | softer with |
| | | | | | | less scales |

In the following experiments, the detergent and the antiscalant were placed directly into the 250-mL stainless steel beakers and ˜200 ml hard water was added. Therefore, the apparent concentration of the detergent in the beakers was actually about 4-5 times as high as compared to the previous experiments.

### Example 8

### Antiscaling Tests with TIDE Mountain Spring Liquid Detergent

Weighed ˜0.67 g of the TIDE Mountain Spring liquid detergent into each of the three 250-mL stainless beakers. One beaker was kept as the blank control in which no Calcium silicate antiscalant was added. In the other two beakers, 0.25 g and 0.5 g of the antiscalant were added, respectively mixed well.

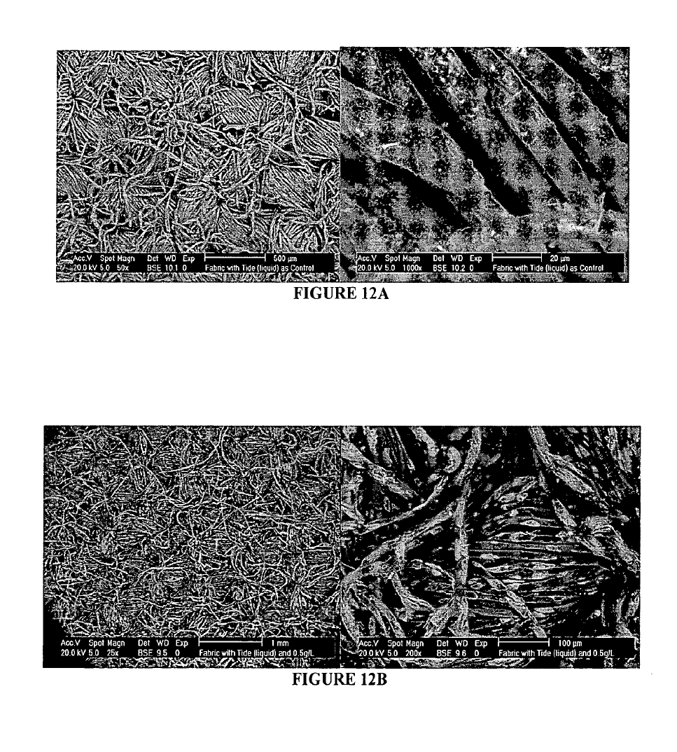

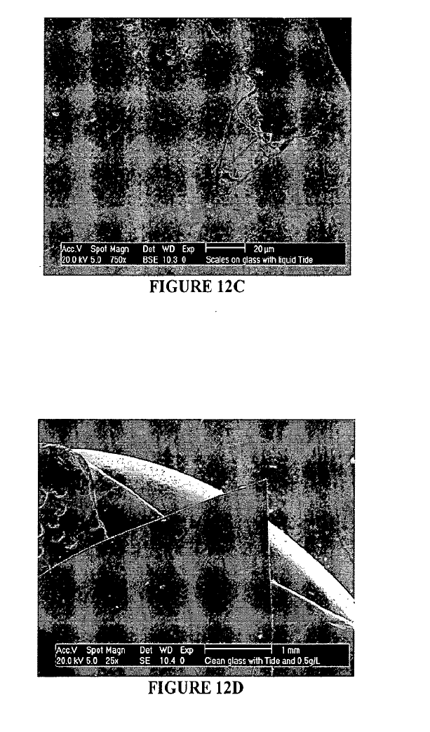

Placed three labeled 250-mL stainless steel beakers on a hotplate and add ˜200 ml hard water, and to make up the evaporated volume afterword with 1000 ml of the hard water, evaporate the water content of each beaker until ˜100 ml liquid left. Table 8 shows the results. SEM images of the fabric and glass samples are shown in the FIGS. 12A-12D.

TABLE 8
Fabric Antiscaling Tests with TIDE Mountain Spring Detergent.

| | Detergent | Original Water | | Residue Water | | |
|---|---|---|---|---|---|---|
| | added | | Cond. | | Cond. | |
| Sample ID | (g/L) | pH | (mS/cm) | pH | (mS/cm) | Comments |
| 0 CS | 0.68 | 6.9 | 962 | 8.61 | 3.65 | Fabric |
| Control | | | | | | became |
| | | | | | | stiff and |
| | | | | | | scales |
| | | | | | | “coated” |
| | | | | | | the fabric |
| 0.25 g CS | 0.68 | 6.9 | 962 | 8.96 | 3.61 | Fabric is |
| Antiscalant | | | | | | softer with |
| | | | | | | less scales |
| 0.5 g CS | 0.66 | 6.9 | 962 | 8.73 | 3.71 | Fabric is |
| Antiscalant | | | | | | softer with |
| | | | | | | less scales |

### Example 9

### Antiscaling Tests with GAIN liquid Detergent

Weighed ˜0.67 g of the GAIN liquid detergent into each of the three 250-mL stainless beakers. One beaker was kept as the blank control in which no Calcium silicate antiscalant was added. In the other two beakers, 0.25 g and 0.5 g of the antiscalant were added respectively, mixed well.

Placed three labeled 250-mL stainless steel beakers on a hotplate and add ˜200 ml of the hard water and to make up the evaporated volume with 1000 ml of the hard water. Evaporate the water content of each beaker until ˜100 ml liquid left.

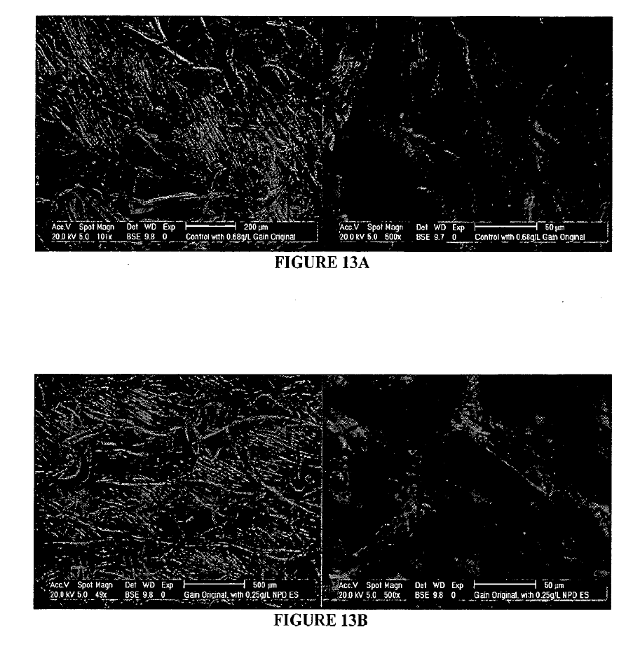

Table 9 shows the results. SEM images of the fabric samples are shown in the FIGS. 13A-13B.

TABLE 9
Fabric Antiscaling Tests with GAIN Liquid Detergent.

| | Detergent | Original Water | | Residue Water | | |
|---|---|---|---|---|---|---|
| | added | | Cond. | | Cond. | |
| Sample ID | (g/L) | pH | (mS/cm) | pH | (mS/cm) | Comments |
| 0 CS | 0.68 | 6.9 | 9.80 | 8.60 | 3.33 | Fabric |
| Control | | | | | | became |
| | | | | | | stiff and |
| | | | | | | scales |
| | | | | | | “coated” |
| | | | | | | the fabric |
| 0.25 g CS | 0.68 | 6.9 | 9.80 | 8.56 | 3.44 | Fabric is |
| Antiscalant | | | | | | softer with |
| | | | | | | less scales |
| 0.5 g CS | 0.69 | 6.9 | 9.80 | 8.83 | 3.24 | Fabric is |
| Antiscalant | | | | | | softer with |
| | | | | | | less scales |

The experiments performed in this study demonstrated that the novel antiscaling technology worked effectively in the prevention or reduction of scale formation on fabrics in hard water where abundant detergent/surfactant was present. Because the new antiscalant is developed based on a new antiscaling mechanism, it apparently works better than Zeolite A in antiscaling, especially in very hard water and at high temperature conditions.

Zeolite builders used in detergent have the function to soften the water due to their high ion exchange capacity, thus to play the role to prevent scale formation in hard water. The use of zeolite builder has been increased due to the adverse environmental impact of phosphate softeners. However, due to stoichiometric ratio or the maximum ion exchange capacity, zeolite builders will be failed in preventing scaling if the total water hardness is passing the thresholds of the ion exchange capacity of the zeolite and the solubility of the scales.

Unlike the conventional antiscaling mechanisms, the novel antiscaling technology is based on a new adsorption/co-precipitation mechanism for scale control, which uses a mineral solid as both an adsorbent to adsorb nucleated microcrystals from suspension and as an initiator or co-precipitator by providing nucleation centers on the mineral surface itself. It can prevent scale formation in super hard waters. The experiments in this study further demonstrated that the new antiscalant works well when surfactant or detergent present in the water.

The antiscaling technology was proven to work well with the presence of a detergent. The antiscalant was effective in a variety of commercial detergents with a detergent loadings from 2000 ppm to 30,000 ppm and an antiscalant loading of 0.25 g/L and 0.50 g/L.

Experiments were also performed to compare the antiscaling effects of Zeolite A and the novel antiscalant, and the results showed that the novel antiscalant is superior in shielding scale formation on the fabrics, while zeolite A failed to prevent scale formation on fabrics in an ultra-hard water environment.

When a high loading of detergent was used, especially, when a powdered detergent, such as the Ultra TIDE, was used, the scale formation or precipitation of solids became complicated, in that the evaporation deposits may formed on the fabrics present. Fabric incrustation became very severe. Even in such conditions, the antiscalant technology still showed some scale shielding effect, and the fabric showed less incrustation.

The results indicated that the novel antiscalant can be used in fabric antiscaling as either a detergent builder or as a separate antiscalant agent in washing process. Due to the unusually high liquid adsorption capacity (water adsorption˜500%), lighter density (˜5 lb/cf), and more dispersable in water, the antiscalant can be used to replace the zeolite builders to provide high liquid holding capacity and better antiscaling effects.

What is claimed is:

1. A laundry detergent composition comprising: a) at least one particulate alkaline earth silicate having a BET surface area ranging from about 1 m²/g to about 500 m²/g; b) one or more surfactants; and c) optionally other ingredients.

2. The laundry detergent of claim 1, wherein the at least one particulate alkaline earth silicate comprises calcium silicate.

3. The laundry detergent of claim 1, wherein the at least one particulate alkaline earth silicate comprises magnesium silicate.

4. The laundry detergent of claim 1, wherein the at least one particulate alkaline earth silicate is a synthetic silicate material.

5. The laundry detergent of claim 4, wherein the synthetic silicate material is derived from diatomaceous earth.

6. The laundry detergent of claim 1, wherein the at least one particulate scale-adsorbent agent has a BET surface area of from about 5 m²/g to about 500 m²/g.

7. The laundry detergent of claim 1, wherein the at least one particulate scale-adsorbent agent has a BET surface area of from about 50 m²/g to about 200 m²/g.

8. The laundry detergent of claim 1, wherein the at least one particulate scale-adsorbent agent has a BET surface area of from about 100 m²/g to about 200 m²/g.

9. The laundry detergent of claim 1, wherein the at least one particulate scale-adsorbent agent has a BET surface area of from about 50 to about 200 m²/g.

10. The laundry detergent of claim 1, wherein the at least one anti-scale material has a median particle size ranging from about 0.1 micron to about 100 microns.

11. The laundry detergent of claim 1, wherein the at least one anti-scale material has a median particle size ranging from about 1 micron to about 50 microns.

12. The laundry detergent of claim 1, wherein the at least one anti-scale material has a median particle size ranging from about 5 microns to about 50 microns.

13. The laundry detergent of claim 1, wherein the at least one anti-scale material has a median particle size ranging from about 10 microns to about 30 microns.

14. The laundry detergent of claim 1, wherein the at least one anti-scale material comprises a calcium silicate having a molar ratio of CaO to SiO₂ ranging from 0.1 to 2.0, such as for example ranging from about 0.4 to about 1.5, ranging from about 0.2 to about 0.6, ranging from about 0.7 to about 1.1, or ranging from about 1.2 to about 1.7.

15. A method for treating a fabric article comprising the steps of: a) providing a solution or dispersion of a particulate alkaline earth silicate in a laundry detergent, wherein the particulate alkaline earth metal silicate has a BET surface area ranging from about 1 m²/g to about 500 m²/g, and; b) contacting a fabric article with said solution or dispersion, wherein the treatment occurs during a laundry cleaning process, preferably the main wash of the laundry process.

16. The method of claim 15, wherein the at least one particulate alkaline earth silicate comprises calcium silicate.

17. The method of claim 15, wherein the at least one particulate alkaline earth silicate comprises magnesium silicate.

18. The method of claim 15, wherein the at least one particulate alkaline earth silicate is a synthetic silicate material.

19. The method of claim 18, wherein the synthetic silicate material is derived from diatomaceous earth.

20. The method of claim 15, wherein the at least one particulate scale-adsorbent agent has a BET surface area of from about 5 m²/g to about 500 m²/g.

21. The method of claim 15, wherein the at least one particulate scale-adsorbent agent has a BET surface area of from about 50 m²/g to about 200 m²/g.

22. The method of claim 15, wherein the at least one particulate scale-adsorbent agent has a BET surface area of from about 100 m²/g to about 200 m²/g.

23. The method of claim 15, wherein the at least one particulate scale-adsorbent agent has a BET surface area of from about 50 to about 200 m²/g.

24. The method of claim 15, wherein the at least one anti-scale material has a median particle size ranging from about 0.1 micron to about 100 microns.

25. The method of claim 15, wherein the at least one anti-scale material has a median particle size ranging from about 1 micron to about 50 microns.

26. The method of claim 15, wherein the at least one anti-scale material has a median particle size ranging from about 5 microns to about 50 microns.

27. The method of claim 15, wherein the at least one anti-scale material has a median particle size ranging from about 10 microns to about 30 microns.
